(19) United States
(12) Patent Application Publication
(10) Pub. No.: US 2006/0259777 A1
(43) Pub. Date: Nov. 16, 2006

(54) Security system for elevator

(75) Inventor: Hirotaka Izawa, Fuchu-shi (JP)

Correspondence Address: FOLEY AND LARDNER LLP;SUITE 500, 3000 K STREET NW, WASHINGTON, DC, 20007, US

(73) Assignee: TOSHIBA ELEVATOR KABUSHIKI KAISHA

(21) Appl. No.: 11/409,278

(22) Filed: Apr. 24, 2006

Related U.S. Application Data
(63) Continuation of application No. PCT/JP04/15734, filed on Oct. 22, 2004.

(30) Foreign Application Priority Data
Oct. 24, 2003 (JP) 2003-365003

(51) Int. Cl. H04K 1/00

(52) U.S. Cl. 713/186

(57) ABSTRACT

In a security system for an elevator which uses an RFID card and a fingerprint authentication device (a biometric authentication device) to authenticate a passenger, data for this authentication is held in a database in a control device. Here, when data must be updated, e.g., when a fingerprint pattern of a new passenger must be registered, a registration unit as a portable terminal device owned by an administrator is used to generate updating data. Further, when the registration unit is connected with the control device at a predetermined position, the updating data is transmitted to the control device to rewrite contents of the database.

### CROSS REFERENCE TO RELATED APPLICATIONS

This is a Continuation Application of PCT Application No. PCT/JP2004/015734, filed Oct. 22, 2004, which was published under PCT Article 21(2) in Japanese.

This application is based upon and claims the benefit of priority from prior Japanese Patent Application No. 2003-365003, filed Oct. 24, 2003, the entire contents of which are incorporated herein by reference.

### BACKGROUND OF THE INVENTION

1. Field of the Invention

The present invention relates to a security system for an elevator provided with a common control panel which can integrate an RFID card and a biometric authentication device (e.g., a fingerprint authentication device).

2. Description of the Related Art

In recent years, in order to assure security of high- and medium-rise buildings, there has been developed a security system for an elevator which authenticates a passenger who uses the elevator based on an RFID card or a fingerprint as disclosed in, e.g., Jpn. Pat. Appln. KOKAI Publication No. 1999-11807 or Jpn. Pat. Appln. KOKAI Publication No. 1999-286378.

In such a security system, it is necessary to set in such a manner that an RFID card cannot be utilized when this card is lost, for example. Further, in fingerprint authentication, it is required to perform daily maintenance of registering/deleting fingerprint patterns of users who frequently counterchange because of moving or the like.

Here, data required for the RFID card or fingerprint authentication is held in a database in a control device provided in accordance with, e.g., a hall on each floor. When contents of this database must be updated for the above-described reasons, both an administrator and a user usually go to a place where an authentication device is installed to perform a predetermined updating operation.

However, this updating operation of the database must be carried out in accordance with each elevator. Therefore, in case of a building provided with a plurality of elevators, an administrator and a user must repeat the same operations at places where the authentication devices are installed in accordance with each of these elevators. That is, if the number of users whose fingerprint patterns must be registered is 100, all of the 100 users must go to positions where a fingerprint device is installed in accordance with each elevator to register their fingerprint patterns.

Further, the thus registered data is stored in the database of the control device. However, when the control device has failed to properly operate for some reasons and data in the database is thereby lost, both an administrator and a user must perform a troublesome operation, e.g., reregistering a fingerprint pattern, and a great burden is imposed on both of them.

Furthermore, in a security system using an RFID card, if an error has occurred, it is impossible to immediately recognize whether its factor exists on an RFID card side or on a system side. Therefore, a manger must make contact with a maintenance company to check a factor as quickly as possible. As a result, if a factor is a damage to the RFID card and the problem can be eliminated by just replacing the RFID card with a new card, a wasteful maintenance/inspection cost is taken.

As described above, in the conventional security system for an elevator, when data required for authentication of an RFID card or fingerprint authentication is updated, both a manger and a user must go to a place where an authentication device is installed in accordance with each elevator set in a building and repeatedly perform a trouble some operation such as registration of a fingerprint pattern there.

Furthermore, when a control device which holds data required for authentication of an RFID card or fingerprint authentication fails to properly operate and data in the control device is thereby lost, both the administrator and the user must again go to each elevator to perform a recovery operation such as re-registration of the fingerprint pattern. Therefore, a great burden in imposed on both the administrator and the user and a very long recovery period is required.

Moreover, since there is no method of judging whether an RFID card is damaged on an administrator side, when a problem occurs, it is necessary to make contact with a maintenance company each time. Therefore, when a damage to the RFID card is a factor, there is a problem, e.g., taking a wasteful maintenance/inspection cost.

Such problems are not restricted to fingerprint authentication, and they are common to other types of biometric authentication (e.g., face authentication, iris authentication, vein authentication, handwriting authentication, or palm shape authentication).

### BRIEF SUMMARY OF THE INVENTION

In view of the above-described problems, it is an object of the present invention to provide a security system for an elevator which can readily perform an updating operation of data required for authentication and safely manage a building without imposing a burden on an administrator or a user.

According to a security system for an elevator of the present invention, there is provided a security system for an elevator which authenticates a passenger who utilizes the elevator, comprising: an RFID card which is owned by the passenger who utilizes the elevator and stores utilized floor information of the passenger therein; an authentication device which accepts biometric information of the passenger; a control device which has a database storing data required for authentication of the passenger by the authentication device, makes reference to the database to authenticate the passenger and controls a destination floor of the elevator based on the utilized floor information of the passenger; and a portable terminal device which is provided with a function of generating data used to update the database by a predetermined operation, transmitting the updating data to the control device to rewrite contents of the database in a state where the terminal device is connected with the control device.

### BRIEF DESCRIPTION OF THE SEVERAL VIEWS OF THE DRAWING

FIG. 1 is a block diagram showing a configuration of a security system for an elevator according to an embodiment of the present invention.

FIG. 2 is a block diagram showing a part of the security system for an elevator according to the embodiment in detail.

FIG. 3 is a view showing an arrangement example of each elevator in a building according to the embodiment.

FIG. 4 is a view showing an exterior appearance structure of a registration unit used in the security system for an elevator according to the embodiment.

FIG. 5 is a block diagram showing an internal structure of the registration unit used in the security system for an elevator according to the embodiment.

FIG. 6 is a flowchart showing a procedure of fingerprint registration by the registration unit used in the security system for an elevator according to the embodiment.

FIG. 7 is a flowchart showing a procedure of fingerprint deletion by the registration unit used in the security system for an elevator according to the embodiment.

FIG. 8 is a flowchart showing a procedure of card ban by the registration unit used in the security system for an elevator according to the embodiment.

FIG. 9 is a flowchart showing a procedure of manger registration by the registration unit used in the security system for an elevator according to the embodiment.

FIG. 10 is a flowchart showing a procedure of information display by the registration unit used in the security system for an elevator according to the embodiment.

FIG. 11 is a flowchart showing a procedure of a set floor change by the registration unit used in the security system for an elevator according to the embodiment.

FIG. 12 is a block diagram showing a part of a security system for an elevator according to a modification of the embodiment in detail.

### DETAILED DESCRIPTION OF THE INVENTION

An embodiment according to the present invention will now be described hereinafter with reference to the accompanying drawings.

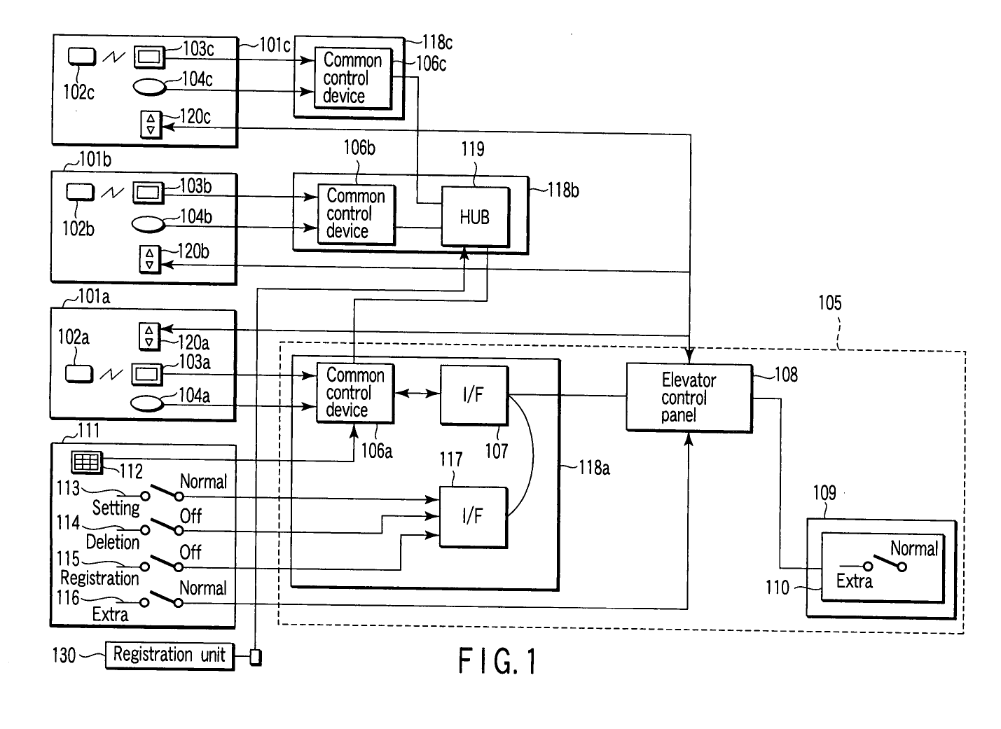

FIG. 1 is a block diagram showing a structure of a security system for an elevator according to an embodiment of the present invention. This FIG. 1 shows a structure as a double security system using both an RFID card and fingerprint authentication. It is to be noted that the fingerprint authentication is the most typical example of biometric authentication.

In FIG. 1, reference numerals 101a to 101c in the drawing denote halls on respective floors (elevator halls). In this system, when both the RFID card and the fingerprint authentication are used in these halls to authenticate a passenger who utilizes the elevators, driving of the elevators with respect to this passenger is controlled. It is to be noted that the passenger may be referred to as a user in the following description in some cases.

Furthermore, the three halls alone are illustrated here. However, if there are more halls, the same security structure is configured with respect to these halls.

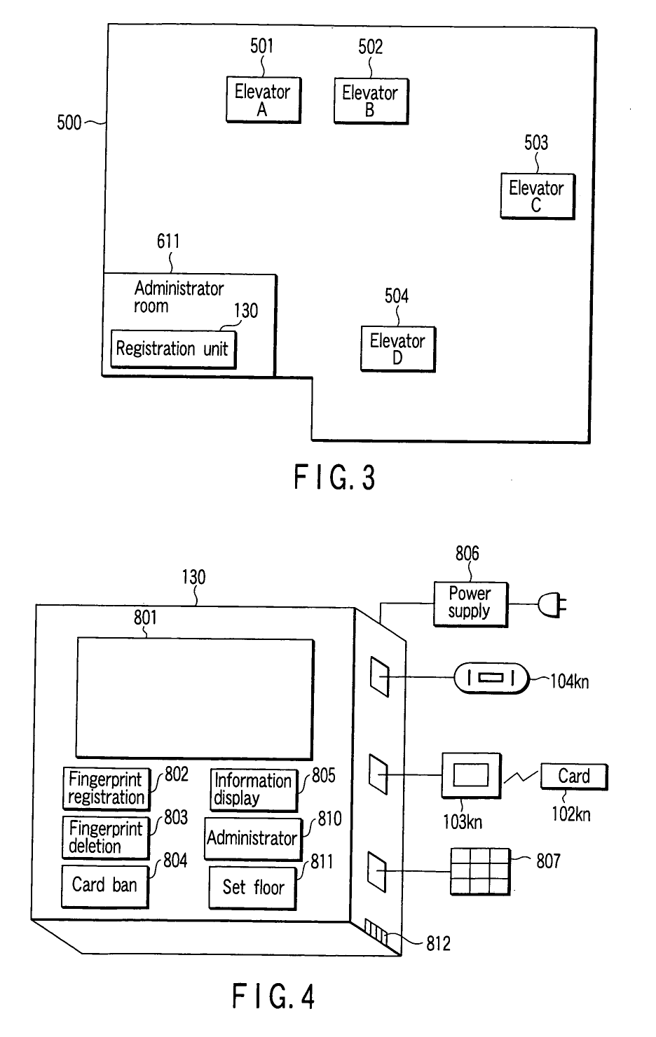

Moreover although the configuration with respect to one elevator alone is illustrated here, the same configuration is adopted in accordance with each elevator. That is, as shown in FIG. 3, in case of a building provided with four elevators A to D, it is assumed that the double security system using both the RFID card and the fingerprint authentication is configured in accordance with each hall on each floor with respect to each of these four elevators as shown in FIG. 1.

In halls 101a to 101c, Reference numerals 102a to 102c denote RFID cards; 103a to 103c, antennas; and 104a to 104c, fingerprint authentication devices (biometric authentication devices).

Each of the RFID card 102a to 102c is an authentication card provided with an RFID function. Utilized floor information and authentication information are stored in each of the RFID cards 102a to 102c. The utilized floor information is information indicative of a floor where a passenger can utilize elevators, and specifies two floors required to get in and out of the building (e.g., in case of a condominium building, a floor where an entrance hall exists and a residential floor). The authentication information includes information required to authenticate a passenger (a passenger name or the like) as well as ID information inherent to each card (identification information).

It is to be noted that an RFID system applied to the RFID cards 102a to 102c is not restricted to a specific type, and a generally known short-range RFID system or the like such as Bluetooth (a registered trade mark) is used.

The antennas 103a to 103c are set at predetermined positions in the halls 101a to 101c. These antennas 103a to 103c receive information RFIDly transmitted from the RFID cards 102a to 102c (the utilized floor information and the authentication information). Card information received by these antennas 103a to 103c is transmitted to later-described RFID/fingerprint common control devices 106a to 106c in boxes on respective elevator floors through a communication cable.

On the other hand, each of the fingerprint authentication devices 104a to 104c is a device which performs authentication based on a fingerprint pattern (biometric information). Each of these fingerprint authentication devices 104a to 104c has a fingerprint sensor screen at a predetermined position in each of the halls 101a to 101c, and accepts a fingerprint pattern at a fingertip pressed against this screen, thereby performing collation processing. After collation of the fingerprint pattern, the utilized floor information and the authentication information corresponding to this passenger are read from a non-illustrated database provided in this device, and these information are transmitted to the later-described RFID/fingerprint common control devices 106a to 106c in the boxes on respective elevator floors through the communication cable.

It is to be noted that a read method or a collation method of the fingerprint pattern in the fingerprint authentication devices 104a to 104c is not restricted to a specific type, and a generally known method is used.

Moreover, in the drawing, reference numeral 105 denotes an elevating path of each elevator; 106a to 106c, the RFID/fingerprint common control devices; 107, an elevator interface (I/F); 108, an elevator control panel; 109, an elevator car; 110, an in-car switch; 111, a maintenance switch box; 112, a numeric keypad; 113 to 116, maintenance switches; 117, a no-voltage contact point elevator interface (I/F); 118a to 118c, elevator floor boxes; 119, an HUB; and 120a to 120c, hall call buttons.

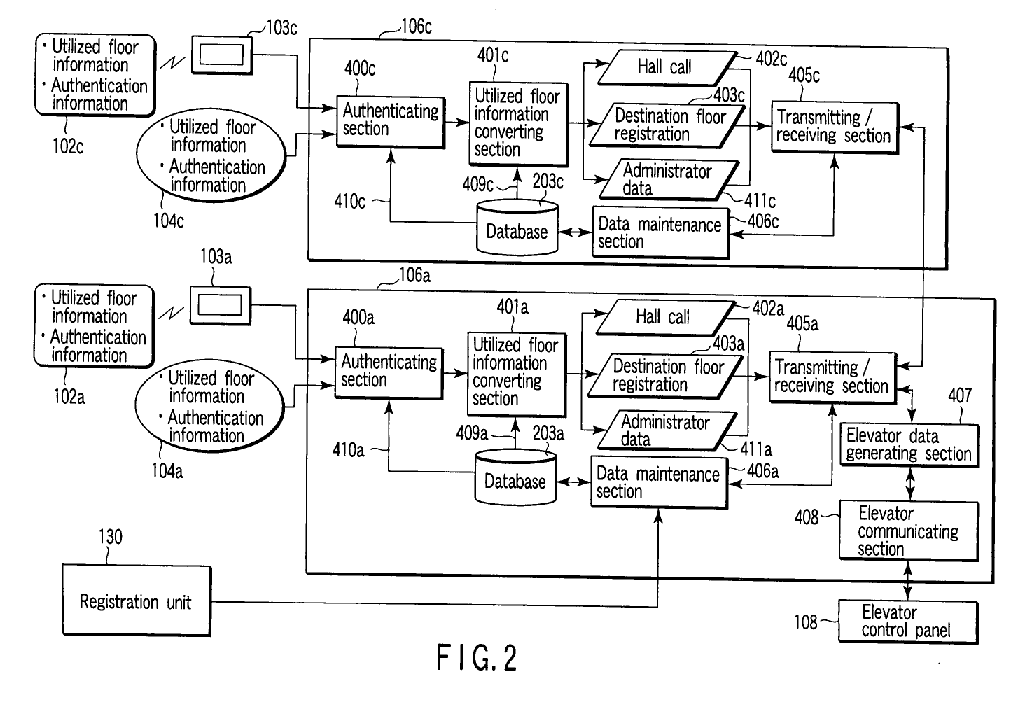

The RFID/fingerprint common control devices 106a to 106c which integrate an RFID card with a fingerprint authentication device are set in the elevator floor boxes 118a to 118c. It is to be noted that a specific structure and a detailed operation of each of these RFID/fingerprint common control devices 106a to 106c will be described later with reference to FIG. 2. These RFID/fingerprint common control devices 106a to 106c are coupled through the HUB 119, and connected with the elevator control panel 108 as a main control device through the elevator interface 107.

The elevator control panel 108 is set in, e.g., a machine room provided on the uppermost floor in the building, and controls over the entire driving of the elevators. For example, this elevator control panel 108 receives a hall call signal transmitted by operating each of the hall call buttons 120a to 120c and controls the elevator car 109 to respond to this hall call. Additionally, this elevator control panel 108 receives a destination floor specifying signal transmitted by operating the in-car switch 110 and controls the elevator car 109 to move to the destination floor, for example.

The elevator car 109 moves up and down in the elevating path 105 through a non-illustrated winder which is driven and controlled by the elevator control panel 108. The switch 110 used to specify a destination floor is provided in this elevator car 109.

Further, the maintenance switch box 111 is set in, e.g., a building administrator room. The numeric keypad 112 or the maintenance switches 113 to 116 are provided in this maintenance switch box 111.

Furthermore, this system is provided with a registration unit 130 in addition to these structures. This registration unit 130 is used for an operation of updating data required for authentication utilizing the RFID card or fingerprint authentication. This registration unit 130 is formed of a portable small terminal device and owned by an administrator. It is to be noted that a configuration of this registration unit 130 will be described later with reference to FIGS. 3 to 5.

A configuration of the security system for an elevator in this embodiment will now be described in detail with reference to FIG. 2.

FIG. 2 is a block diagram showing a part of the security system depicted in FIG. 1 in detail. Prior to explaining an example, a passenger A who utilizes a fourth floor and a first floor in a building such as a condominium building is assumed. It is assumed that the fourth floor is a residential floor for this passenger and the first floor is a floor where the entrance hall exists.

In FIG. 2, the RFID card 102c, the antenna 103c and the fingerprint authentication device 104c are set in the hall on the fourth floor. Moreover, the RFID/fingerprint authentication common control device 106c is set in the elevating path on the forth floor. On the other hand, the RFID card 102a, the antenna 103a and the fingerprint authentication device 104a are set in the hall on the first floor, and the RFID/fingerprint authentication common control device 106a is set in the elevating path on the first floor.

Utilized floor information indicative of floors utilized by the passenger and authentication information are previously stored in the RFID cards 102a to 102c and the fingerprint authentication devices 104a to 104c. The passenger A has the RFID card having his/her utilized floor information (the fourth floor and the first floor) and the authentication information (a card number or the like). On the contrary, an administrator of this building has an RFID card dedicated to the administrator in which authentication information alone is stored as a master card.

Q When the passenger A goes to the hall on the fourth floor, the information in the RFID card 102c of this passenger A is RFIDly transmitted and received by the antenna 103c set in the hall on the fourth floor. The card information received by this antenna 103c enters the RFID/fingerprint common control device 106c set in the fourth-floor box 118c to be transmitted to an authenticating section 400c.

When the fingerprint authentication device 104c as well as the RFID card is set, the authenticating section 400c waits for the utilized floor information and the authentication information of the passenger A obtained as a result of authentication to be transmitted from the fingerprint authentication device 104c.

It is to be noted that reading to collation of a fingerprint pattern of each passenger are carried out in the fingerprint authentication devices 104a to 104c set on the hall side in this embodiment, but different structures may be adopted to perform such processing. That is, for example, the fingerprint authentication devices 104a to 104c may perform reading of a fingerprint pattern of each passenger alone, and the RFID/fingerprint common control devices 106a to 106c may receive the read fingerprint pattern and collate it with a fingerprint pattern registered in each of databases 203a to 203c, thereby effecting collation processing.

Moreover, in this system, authentication using the RFID card alone, authentication using a fingerprint alone or authentication using a combination of the RFID card and the fingerprint can be arbitrarily selected at the time of, e.g., delivery of the system. In this case, when fingerprint authentication is performed in addition to authentication using the RFID card, a security level is increased, but collation with a fingerprint pattern takes time.

Again referring to FIG. 2, the authenticating section 400c compares the authentication information obtained from the RFID card 102c or the fingerprint authentication device 104c with authentication information previously registered in the database 203c to judge who the passenger A is.

Here, when the passenger A is an administrator of the building, a utilized floor information converting section 401c generates administrator data 411c. The administrator data 411c is data which specifies an operation dedicated to the administrator.

When the passenger A is not the administrator, i.e., the passenger A is a general passenger, a hall call calculation and a destination floor registration calculation are carried out based on utilized floor information obtained together with the authentication information and a set floor stored in the database 203c, thereby generating a hall call 402c and destination floor registration 403c. In this case, the utilized floor information is the fourth floor and the first floor utilized by the passenger A, and the set floor is the fourth floor. Therefore, data indicative of the fourth floor as the hall call 402c and data indicative of the first floor as the destination floor registration 403c are generated.

Incidentally, when the RFID card is lost, registering a card number of this card in the databases 203a to 203c on the respective floors can reject authentication using this RFID card by authentication rejection data 410a to 410c if an RFID card having this registered card number is used.

The data of the hall call 402c and the destination floor registration 403c or the administrator data 411c generated by the utilized floor information converting section 401c is transmitted to the RFID/fingerprint authentication common control device 106a on the first floor through a transmitting/receiving section 405c. The RFID/fingerprint authentication common control panel 106a receives these data in the transmitting/receiving section 405a.

An authentication method and a processing method in the RFID card 102a and the fingerprint authentication device 104a are the same operations as those of the RFID card 102c and the fingerprint authentication device 104c, thereby eliminating their explanations.

Information of all floors are transmitted to an elevator data generating section 407 through a transmitting/receiving section 405a in the RFID/fingerprint authentication common control panel 106a. Here, the information is organized for elevator control, and this information is transmitted by an elevator communicating section 408 to the elevator control panel 108 through the elevator interface 107.

The elevator control panel 108 performs an operation corresponding to a customer based such information. That is, it controls an operation control in such a manner that the elevator car 109 is allowed to respond to the fourth-floor hall with respect to the passenger A, then in-car destination floor registration is set to the first floor and the passenger A is directly carried to the first floor.

Further, in case of the building administrator, the elevator control panel 108 allows the administrator alone to perform an operation of nonstop cancellation and switches the current state to a state in which hall call and in-car destination floor registration can be freely performed. As a result, the administrator can freely go to all the floors in the building with one master card alone without bringing a plurality of cards with him/her.

The registration unit 130 used in this system will now be described with reference to FIGS. 3 to 5.

FIG. 3 is a view showing an arrangement example of each elevator in a building. In the drawing, reference numeral 500 denotes a building; 501, an elevator A; 502, an elevator B; 503, an elevator C; and 504, an elevator D. Furthermore, reference numeral 611 designates an administrator room, and the registration unit 130 is stored in this room.

In case of updating data required for authentication of the RFID card or the fingerprint, the manger can adopt a method of calling a user to the administrator room 611 to update data by using the registration unit 130, or a method of bringing the registration unit 130 to the user to update data there.

The updated data is held in the registration unit 130. Therefore, the administrator brings it into each of the elevator A 501, the elevator B 502, the elevator C 503 and the elevator D 504 to transmit the data in the registration unit 130 to the common control devices 106a to 106c of the respective floors depicted in FIG. 1, thereby reflecting the data in the databases 203a to 203c in the common control devices 106a to 106c.

In this case, when the administrator connects the registration unit 130 with a connector set in an elevator hall on a given floor (e.g., the first floor) without going to every floors, the updated data can be transmitted to the common control devices 106a to 106c on the respective floors through an LAN cable at the same time.

FIG. 4 is a view showing an external appearance structure of the registration unit 130 used in this system.

This registration unit 130 is constituted of a portable small terminal device. On an operation surface of this registration unit 130 are provided a screen display section 801, a “fingerprint registration” button 802, a “fingerprint deletion” button 803, a “card ban” button 804, an “information display” button 805, a “administrator” button 810 and a “set floor” button 811.

The screen display section 801 is formed of, e.g., an LCD (Liquid Crystal Display) and displays various kinds of data required for a data registration operation. The “fingerprint registration” button 802 is used when registering a fingerprint pattern. The “fingerprint deletion” button 803 is used when registering a fingerprint pattern. The “card ban” button 804 is used to inhibit authentication utilizing the RFID card when this RFID card is lost. The “administrator” button 810 is used when registering an administrator. The “set floor” button 811 is used when registering a set floor.

Moreover, a power supply 806, a numeric pad 807, an antenna 103kn and a fingerprint authentication device (a biometric authentication device) 104kn are connected with a side surface of a main body of this registration unit 130. They are attachable/detachable, and can be attached to the main body as required.

Additionally, a connector 812 used to be connected with the LAN cable of each elevator is provided on the side surface of the main body of this registration unit 130.

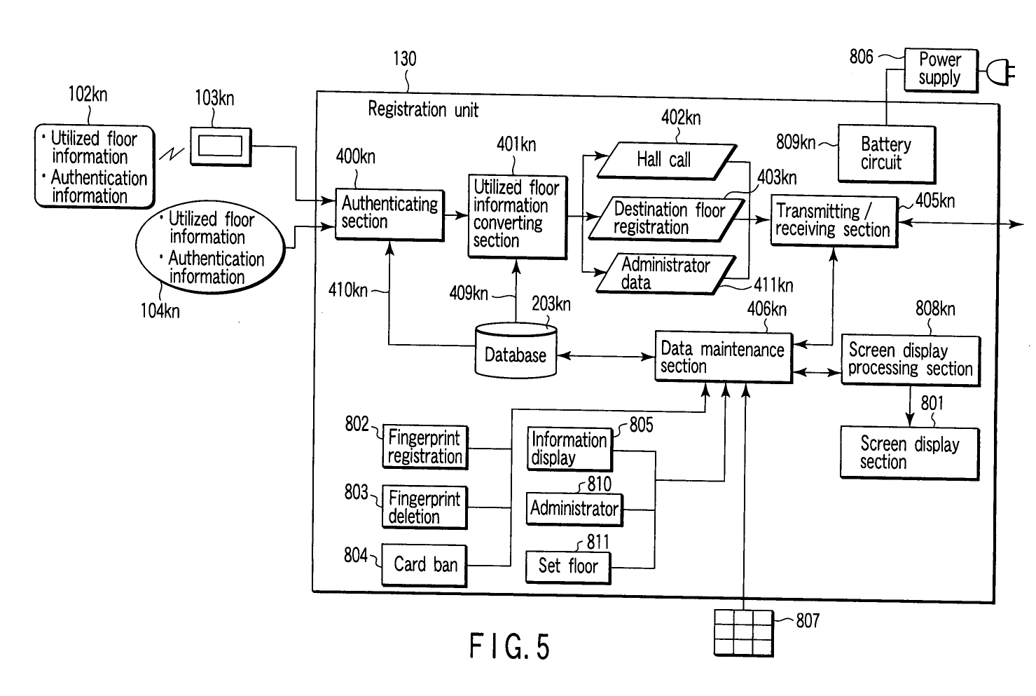

FIG. 5 is a block diagram showing an internal structure of the registration unit 130, and like reference numerals denote the same parts equal to those in FIG. 4.

The registration unit 130 has an authenticating section 400kn, a utilized floor information converting section 401kn, a hall call 402kn, a destination floor registration 403kn, administrator data 411kn, a converting section 405kn, authentication rejection data 410kn, a set floor 409kn, a database 203kn, a data maintenance section 405kn and others like the RFID/fingerprint common control devices 106a to 106c provided in the halls on the respective floors. Besides, this registration unit 130 is provided with a screen display processing section 808kn and a battery circuit 809kn.

The battery circuit 809kn is charged by connecting the power supply 806. After charging, the power supply 806 is removed from the registration unit 130, and this battery circuit 809 can be used as a drive source.

Further, the “fingerprint registration” button 802, the “fingerprint deletion” button 803, the “card ban” button 804, the “information display” button 805, the “administrator” button 810, the “set floor” button 811 and the numeric keypad 807 are connected with the data maintenance section 405kn. This data maintenance section 406kn displays a screen concerning operations of these buttons 802 to 811 in the screen display section 801 through the screen display processing section 808kn.

Operations of this registration unit 130 will now be described hereinafter in accordance with each of (a) fingerprint registration, (b) fingerprint deletion, (c) card ban, (d) administrator registration, (e) information display and (f) a set floor change.

These operations are carried out when the administrator calls a user to the administrator room 811 or the administrator brings the registration unit 130 to the user's place as described in conjunction with FIG. 3. At this time, as shown in FIG. 4, the numeric keypad 807 is attached to the side surface of the main body of the registration unit 130, and the fingerprint authentication device 104kn or the antenna 103kn of the RFID card is also attached as required.

(a) Fingerprint Registration (Biometric Information Registration)

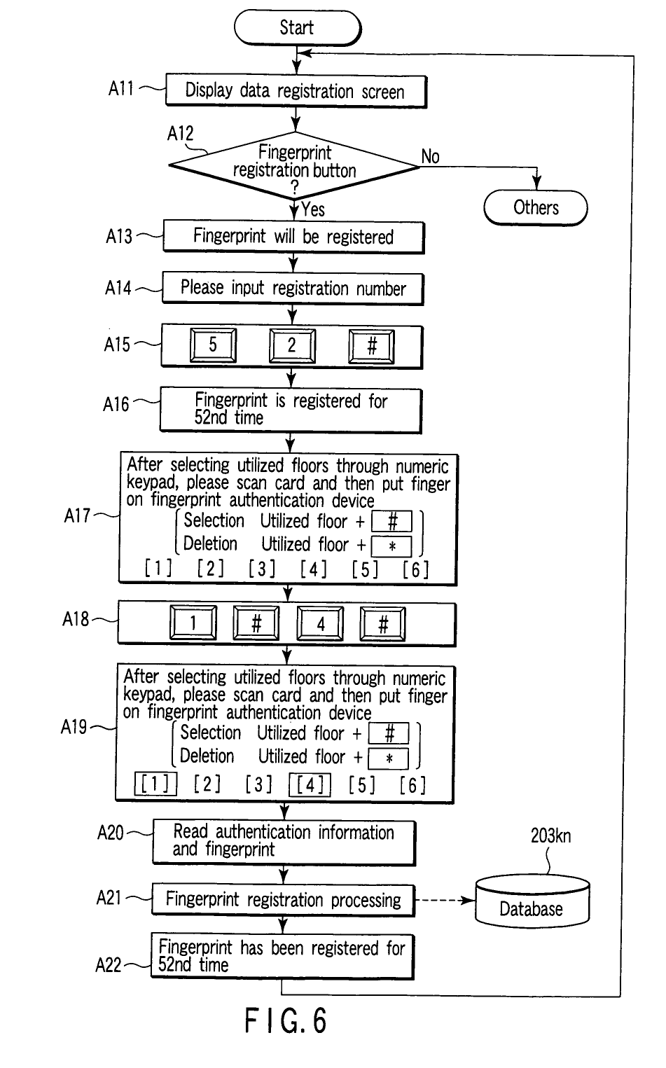

First, a description will be given as to a case of registering a fingerprint pattern with reference to FIG. 6.

FIG. 6 is a flowchart showing a procedure of fingerprint registration using the registration unit 130 of this system. First, when the power supply of the registration unit 130 is turned on by operating a non-illustrated power supply button or the like, an initial screen for data registration is displayed in the screen display section 801 of the registration unit 130 (stepA11).

In this state, when the administrator presses the “fingerprint registration” button 802 of the registration unit 130 (Yes at stepA12), a message screen indicating “fingerprint will be registered” is displayed (stepA13). Furthermore, after one second, the current screen is switched to a screen indicating “please input registration number” (stepA14).

A description will be given on the assumption that a fingerprint pattern is registered for the 52nd time. It is to be noted that a user can arbitrarily select this registration number. Information of respective users (fingerprint patterns, card numbers and others) are managed in the RFID/fingerprint common control devices 106a to 106c on the respective floors of the elevators based on the registration numbers.

In order to register the fingerprint for the 52nd time, the administrator first inputs data such as “5”, “2”, “#” or the like by using the numeric keypad 807 connected with the registration unit 130 (stepA15). As a result, a confirmation screen indicating, e.g., “fingerprint will be registered for 52nd time” is displayed. Moreover, after one section, a message screen “after selecting utilized floors through numeric keypad, please scan card and then put finger on fingerprint authentication device” is displayed. In this example, in case of a six-story building, a screen of a utilized floor status of 6 floors, e.g., [1], [2] . . . [6] is displayed.

Assuming that utilized floors are first and fourth floors, the administrator inputs data such as “1”, “#”, “4”, “#” or the like by using the numeric keypad 807 in order to register the utilized floors (stepA18). With this key input, a background color of [1] and [4] of [1], [2], . . . [6] in the screen is changed (stepA19). As a result, it can be recognized that the first floor and the fourth floor are selected as utilized floors. If a mistake is made, it can be eliminated by inputting “utilized floor +*” from the numeric keypad 807.

After selecting the utilized floors, the RFID card 102kn of the user is moved closer to the antenna 103kn connected with the registration unit 130. As a result, authentication information (a card number or the like) registered in this RFID card 102kn is read and temporarily stored in the authenticating section 400kn. Additionally, a finger of the user is pressed against a sensor screen of the fingerprint authentication device 104k connected with the registration unit 130. As a result, this fingerprint pattern is transmitted to the authenticating section 400kn and temporarily stored together with the authentication information (stepA20).

After reading the authentication information and the fingerprint pattern of the user in this manner, when the administrator again presses the “fingerprint registration” button 802, the selected utilized floor information (the first floor and the fourth floor) and the authentication information and the fingerprint pattern temporarily stored in the authenticating section 400kn are registered in the database 203kn in the registration unit 130 (stepA21). At this time, a completion notifying screen “fingerprint has been registered for 52nd time” is displayed (stepA22).

Thereafter, fingerprint patterns of other users can be successively registered based on the same operations. After registering the fingerprint pattern, the administrator brings this registration unit 130 to the respective elevators 501 to 504 depicted in FIG. 3.

Furthermore, connecting the LAN cable to the connector 512 of the registration unit 130 in the hall on a specific floor (e.g., the first floor) in accordance with each of these elevators 501 to 504 transmits the data registered in the database 203kn in this registration unit 130 to the RFID/fingerprint common control devices 106a to 106c on the respective floors through the LAN cable. As a result, contents of the databases 203a to 203c in the RFID/fingerprint common control devices 106a to 106c are updated. It is to be noted that the method of updating the data in this example will be described later in detail with reference to FIGS. 2 and 5.

(b) Fingerprint Deletion (Biometric Information Deletion)

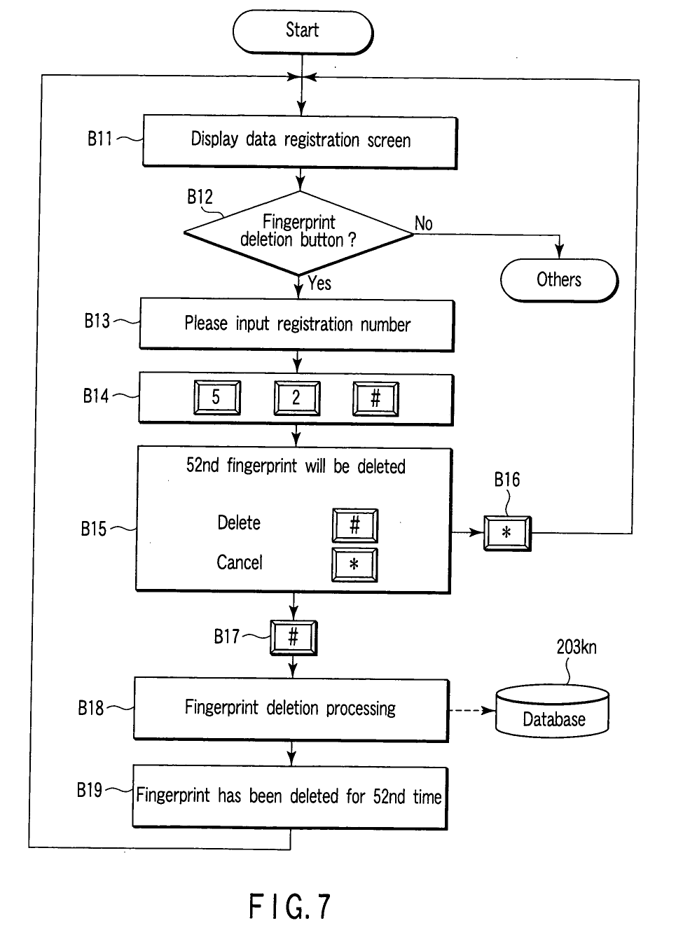

A description will now be given as to a case where a fingerprint pattern is deleted with reference to FIG. 7.

FIG. 7 is a flowchart showing a procedure of fingerprint deletion using the registration unit 130 of this system. First, when the power supply of the registration unit 130 is turned on by operating a non-illustrated power supply button or the like, the initial screen for data registration is displayed in the screen display section 801 of the registration unit 130 (stepB11).

In this state, when the administrator presses the “fingerprint deletion” button 803 of the registration unit 130 (Yes at stepB12), a screen “please input registration number” is displayed (stepB13).

A description will be given on the assumption that the 52nd fingerprint pattern will be deleted.

In order to delete the 52nd fingerprint pattern, the administrator first inputs data such as “5”, “2”, “#” or the like by using the numeric keypad 807 connected with the registration unit 130 (stepB14). As a result, a confirmation screen, e.g., “52nd fingerprint will be deleted” is displayed (stepB15). At this time, when a key “*” is input from the numeric keypad 807 (stepB16), fingerprint deletion processing is not carried out, and the current screen returns to the initial screen of stepB11.

Moreover, when a key “#” is input from the numeric keypad 807 (stepB17), a fingerprint pattern which has been registered for the 52nd time is retrieved from the database 203kn, and this fingerprint pattern, authentication information concerning this fingerprint pattern and utilized floor information are deleted from the database 203kn (stepB18). At this time, a completion notifying screen “52nd fingerprint has been deleted” is displayed (stepB19).

Thereafter, other fingerprint patterns can be successively deleted by the same operations. Then, like the example of registering the fingerprint pattern, when the administrator brings the registration unit 130 to the respective elevators 501 to 504 to transmit the data in the database 203kn to the RFID/fingerprint common control devices 106a to 106c on the respective floors, contents of the databases 203a to 203c in the RFID/fingerprint common control devices 106a to 106c can be updated.

(c) Card Ban

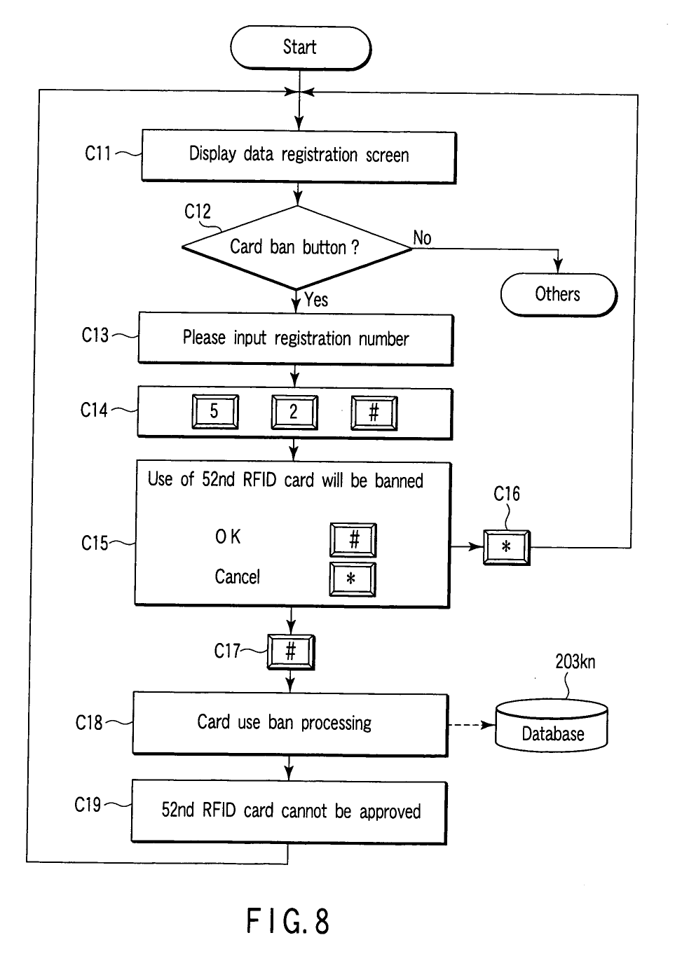

A description will now be given as to a case where authentication utilizing the RFID card is banned with reference to FIG. 8.

Utilized floor information and authentication information are registered in the RFID card owned by each user. When this RFID card is used to perform authentication, the user can got on each elevator to go to a floor specified by the utilized floor information. Therefore, when the RFID card is lost, this RFID card must be immediately invalidated. An operation in this case can be also executed by using the registration unit 130.

FIG. 8 is a flowchart showing a procedure of card ban using the registration unit 130 of this system. First, when the power supply of the registration unit 130 is turned on by operating a non-illustrated power supply button or the like, the initial screen for data registration is displayed in the screen display section 801 of the registration unit 130 (stepC11).

In this state, when the administrator presses the “card ban” button 804 of the registration unit 130 (Yes at stepC12), a screen “please input registration number” is displayed (stepC13).

A description will be given on the assumption that authentication utilizing the 52nd RFID card will be banned.

In order to invalidate the 52nd RFID card, the administrator first inputs data such as “5”, “2”, “#” or the like by using the numeric keypad 807 connected with the registration unit 130 (stepC14). As a result, a confirmation screen, e.g., “use of 52nd RFID card will be banned” is displayed (stepC15). At this time, when the key “*” is input from the numeric keypad 807 (stepC16), RFID card ban processing is not carried out, and the current screen returns to the initial screen of stepC11.

Further, when the key “#” is input from the numeric keypad 807 (stepC17), identification information (a card number) of this 52nd RFID card is registered as authentication rejection data 410kn in the database 203kn (stepC18). At this time, a completion notifying screen “52nd RFID card cannot be approved” is displayed (stepC19).

Thereafter, other RFID cards can be successively invalidated by the same operations. Then, like the example of registering the fingerprint pattern, when the administrator brings the registration unit 130 to the respective elevators 501 to 504 to transmit the data in the database 203kn to the RFID/fingerprint common control devices 106a to 106c on the respective floors, contents of the databases 203a to 203c in the RFID/fingerprint common control devices 106a to 106c can be updated.

As a result, when the invalidated RFID card is used on, e.g., the first floor, authentication of this card can be rejected by using authentication rejection data 410a in the database 203a to prevent a stranger from illicitly entering the building.

(d) Administrator Registration

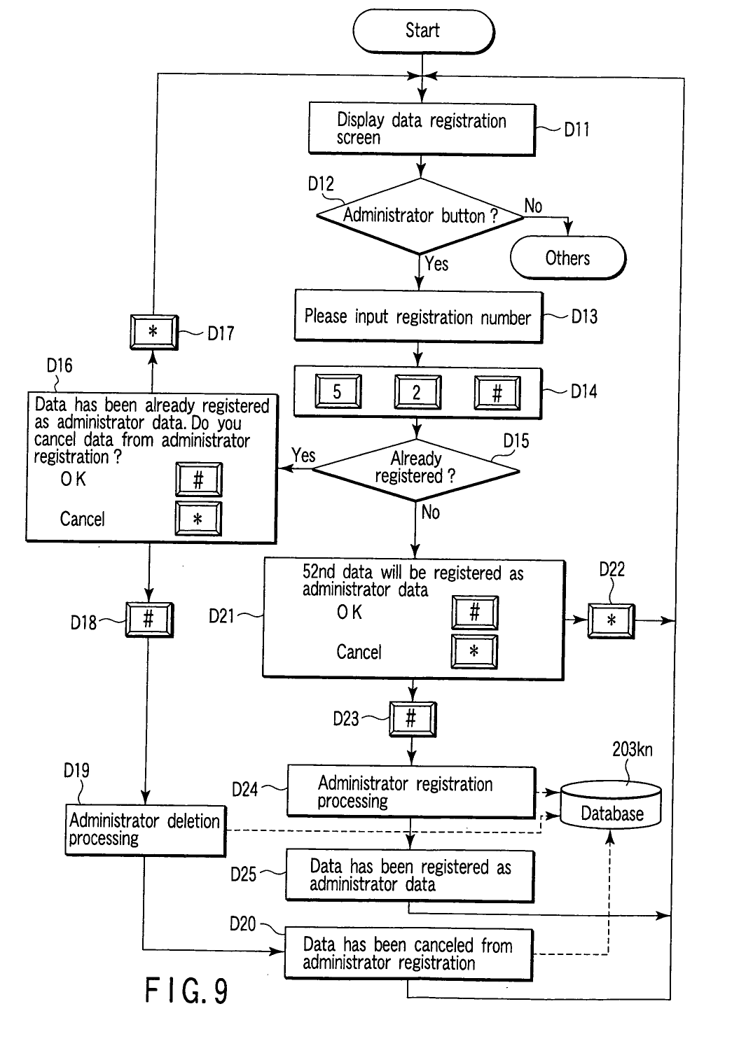

A description will now be given as to an example where an administrator is registered with reference to FIG. 9.

In case of adopting a configuration in which destination floors of a user are automatically registered based on utilized floor information registered in the RFID card, operations of the elevators must be switched to be different from operations with respect to general passengers in such a manner that an administrator can freely go to all floors by using one RFID card (a master card). In this case, the administrator must be registered in advance, and its registration operation can be also performed by using the registration unit 130.

FIG. 9 is a flowchart showing a procedure of administrator registration using the registration unit 130 of this system. First, when a power supply of the registration unit 130 is turned on by operating a non-illustrated power supply button or the like, the initial screen for data registration is displayed in the screen display section 801 of the registration unit 130 (stepD11).

In this state, when the administrator presses the “administrator” button 810 of the registration unit 130 (Yes at stepD12), a screen “please input registration number” is displayed (stepD13).

Here, in a case where the 52nd data is processed as administrator data, the administrator inputs data such as “5”, “2”, “#” or the like by using the numeric keypad 807 connected with the registration unit 130 (stepD14). As a result, the 52nd data in the database 230kn is retrieved, and whether this data has been already registered as administrator data is judged (stepD15).

When the 52nd data has been already registered as an administrator data (Yes at stepD15), a confirmation screen indicating, e.g., “data has been already registered as administrator data. Do you cancel data from administrator registration?” is displayed (stepD16). In case of maintaining the data as the administrator data, when the key “*” is input from the numeric keypad 807, the current screen directly returns to the initial screen of stepD11.

In case of canceling the data from being processed as the administrator data, inputting the key “#” from the numeric keypad 807 (stepD18) cancels the 52nd data in the database 203kn from being processed as the administrator data (stepD19). At this time, a message indicating “data has been canceled from administrator registration” is displayed (stepD20), and the current screen returns to the initial screen of stepD11.

Furthermore, when the 52nd data has not been registered as administrator data at stepD15, a confirmation screen indicating, e.g., “52nd data will be registered as administrator data” is displayed (stepD21). In case of abandoning administrator registration, when the key “*” is input from the numeric keypad 807 (stepD22), the current screen returns to the initial screen of stepD11.

Moreover, when the key “#” is input from the numeric keypad 807 (stepD23), the 52nd data in the database 203kn is registered as administrator data (stepD24). At this time, a completion notifying screen indicating, e.g., “data has been registered as administrator data” is displayed (stepD25).

After performing administrator registration in the registration unit 130 in this manner, like the example of registration of the fingerprint pattern, when the administrator brings the registration unit 130 to the respective elevators 501 to 504 to transmit the data in the database 203kn to the RFID/fingerprint common control devices 106a to 106c on the respective floors, contents of the databases 203a to 203c in the RFID/fingerprint common control devices 106a to 106c can be updated. As a result, the 52nd data can be determined as the administrator data, and the respective elevators 501 to 504 can be switched to the operations dedicated to the administrator.

(e) Information Display

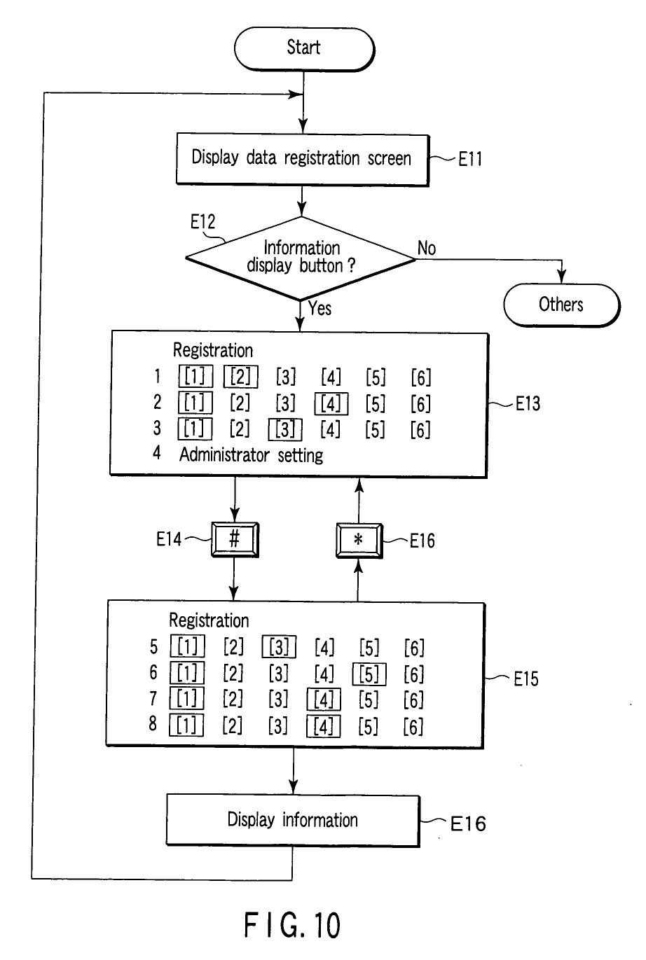

A description will now be given as to an example of performing information display with reference to FIG. 10.

When the number of times of performing registration is increased, what information has been currently registered should be confirmed. In such a case, when the “information display” button 805 of the registration unit 130 is pressed, current registration information is displayed.

FIG. 10 is a flowchart showing a procedure of information display using the registration unit 130 of this system. First, when the power supply of the registration unit 130 is turned on by operating a non-illustrated power supply button or the like, the initial screen for data registration is displayed in the screen display section 801 of the registration unit 130 (stepE11).

In this state, when the administrator presses the “information display” button 805 of the registration unit 130 (Yes at stepE12), an illustrated information display screen is displayed (stepE13). This information display screen shows information currently registered in the database 203kn in a predetermined format, and a predetermined number of sets of utilized floor information are displayed in accordance with respective registration numbers.

For example, it is possible to recognized at first sight in the screen that the first and second floors are registered as utilized floors in case of a registration number “1”, the first and fourth floors are registered as utilized floors in case of a registration number “2” and the first and third floors are registered as utilized floors in case of a registration number “3”. Further, in case of an administrator, “administrator setting” is displayed. In this example, a registration number “4” is set as an administrator.

Furthermore, when the key “#” in the numeric keypad 807 is input (stepE14), the next screen is displayed (stepE15). When the key “*” is input (stepE16), a previous screen is displayed (stepE13) Moreover, when the “information display” button 805 is again pressed in a state where the information display screen is displayed (stepE16), the original initial screen for data registration is displayed (stepE11).

When information currently registered in the registration unit 130 is displayed in the screen in this manner, whether registered contents has, e.g., an error can be confirmed and the confirmed contents can be then transmitted to the RFID/fingerprint common control devices 106a to 106c on the respective floors, thereby updating data.

(Data Updating Method)

A description will now be given as to an example where an administrator updates contents of the databases 203a to 203c by using the registration unit 130.

As described above, after performing an operation, e.g., registration of a fingerprint pattern using the registration unit 130, the administrator goes to a hall on a specific floor (e.g., the first floor) and connects the LAN cable set at a predetermined position in this hall with the connector 812 of the registration unit 130. An end of this LAN cable is connected with the HUB 119 as shown in FIG. 1, and the RFID/fingerprint common control devices 106a to 106c on the respective floors are connected with this HUB 119.

When the LAN cable is connected with the connector 812 of the registration unit 130, the transmitting/receiving section 405kn in the registration unit 130 shown in FIG. 5 recognizes this state and informs the data maintenance section 406kn that the registration unit 130 is connected with the system. Upon receiving this information, the data maintenance section 406kn prepares to start communication with the data maintenance section 406a in the RFID/fingerprint common control device 106a on a specific floor (e.g., the first floor).

When the preparation for accepting data updating is completed, the data maintenance section 406a in the RFID/fingerprint common control device 106a outputs an acceptance enabled signal to the data maintenance section 406kn. When the data maintenance section 406kn receives this acceptance signal, it transmits contents of the database 203kn to the data maintenance section 406a. The data maintenance section 406a receives this data to update contents of the database 203a. Then, the data maintenance section 406a communicates with the RFID/fingerprint common control devices 106b and 106c set on the other floors to eventually update the databases in the RFID/fingerprint common control devices on all the floors in accordance with the database contents of the registration unit 130.

When the registration unit 130 is connected with the LAN cable on a specific floor in this manner, the databases 203a to 203c in the RFID/fingerprint common control devices 106a to 106c on the respective floors can be updated in accordance with data contents held in the registration unit 130. When this updating operation is likewise carried out to the respective elevators 501 to 504 shown in FIG. 3, the data updating operation is brought to completion.

In this case, it is good enough for the administrator only to go the respective elevators 501 to 504 in order to update data, and hence no burden is imposed on a user. Additionally, the operation performed by the administrator in the respective elevators 501 to 504 is a simple operation, e.g., connecting the registration unit 130 to the LAN cable as described above, and there is no need to perform a troublesome operation in the elevators. Therefore, a burden on the administrator is small.

(Card Damage Confirmation)

Meanwhile, there is a case where information registered in the RFID card cannot be read during an operation. Conventionally, a maintenance company is called since whether a factor of such an error exists on the RFID card side or the system side cannot be judged, but using the registration unit 130 according to the present invention can readily check the factor.

That is, as shown in FIG. 5, when the RFID card 102kn is moved close to the antenna 103kn, authentication information and utilized floor information are transmitted to the authenticating section 400kn if this RFID card 102kn is normal. When authentication is made, information of the set floor 409kn is obtained from the database 203kn by the utilized floor information converting section 401kn, and the hall call 402kn, the destination floor registration 403kn and the administrator data 411kn are generated and transmitted to the transmitting/receiving section 405kn.

Here, if the registration 130 is not connected with the system, the transmitting/receiving section 405kn transmits the hall call 402kn, the destination floor registration 403kn and the administrator data 411kn to the screen display processing section 808kn. As a result, the screen display processing section 808kn displays such information in the screen display section 801. At this time, if the RFID card 102kn is broken, nothing is displayed in the screen display section 801. Therefore, it can be determined that a factor of the error exists on the RFID card side.

(f) Change in Set Floor

In order to generate the hall call 402kn, the destination floor registration 403kn and the administrator data 411kn, information of the set floor 409kn is required in the database 203kn. In the registration unit 130, this set floor information can be arbitrarily changed.

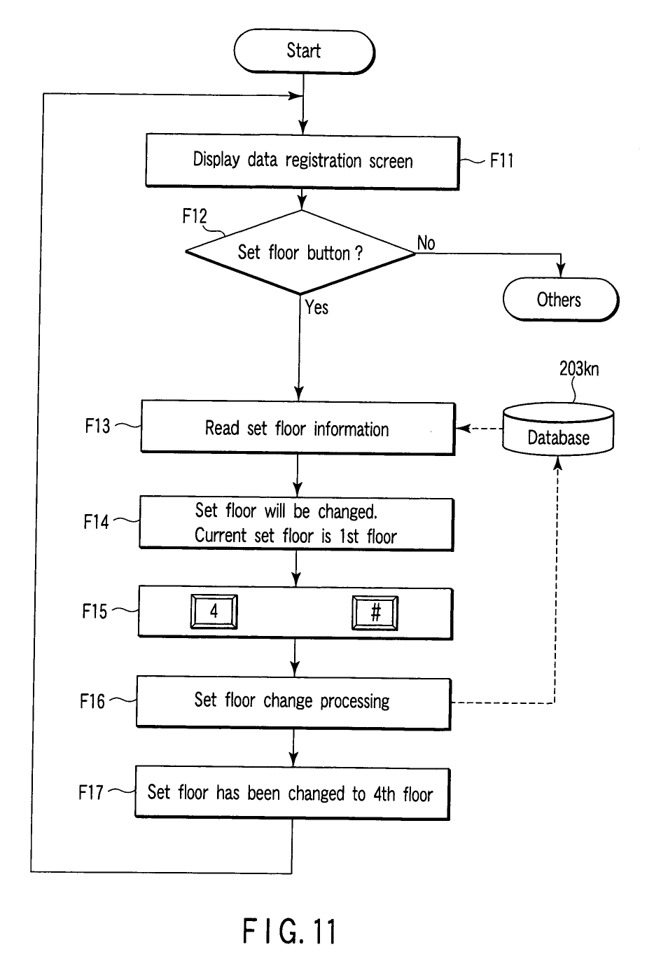

FIG. 11 is a flowchart showing a procedure of changing a set floor by the registration unit 130 in this system. First, when the power supply of the registration unit 130 is turned on by operating a non-illustrated power supply button or the like, the initial screen for data registration is displayed in the screen display portion 801 of the registration unit 130 (stepF11).

When the administrator presses the “administrator” button 810 of the registration unit 130 in this state (Yes at stepF12), set floor information is read from the database 203kn in the registration unit 130 (stepF13). Assuming that the first floor is registered as the set floor information, a message screen indicating, e.g., “set floor will be changed. Current set floor is 1st floor” is displayed (stepF14). Based on display of this message screen, the administrator can determine the current set floor.

Here, assuming that the current set floor is changed to, e.g., a fourth floor, the administrator uses the numeric keypad 807 connected with the registration unit 130 to input data such as “4”, “#” or the like (stepF15). As a result, the set floor information in the database 203kn is changed from the first floor to the fourth floor (stepF16), and a completion notifying screen indicating “set floor has been changed to 4th floor” is displayed (stepF17).

In this manner, the set floor in the registration unit 130 can be arbitrarily changed. Therefore, during an operation, if there is an inquiry of the RFID card from a user of the fourth floor, the set floor can be changed to the fourth floor, and each information, e.g., the hall call 402kn, the destination floor registration 403kn and the administrator data 411kn can be generated and displayed. As a result, whether the RFID card is normal can be checked.

As described above, in a case where the plurality of elevators 501 to 504 exist in the building as shown in FIG. 3, if the registration unit 130 according to the present invention is used, calling a user to the administrator room 611 or the like in advance and registering data required for data updating (a fingerprint pattern or the like) in the registration unit 130 can readily update data when the administrator brings this registration unit 130 to the elevators 501 to 504.

In this case, even if the number of users is large, using one registration unit 130 can suffice. Furthermore, the most recent information necessarily remains in the database 203kn in the registration unit 130. Therefore, even if the common control device on the system side is damaged for some reason and data is thereby lost, the most recent information can be easily reflected in the replaced common control device.

Moreover, the registration unit 130 can be used to confirm whether the RFID card is normally operating. Therefore, if card information cannot be read and a factor of this error does not exist in the RFID card, making contact with a maintenance company to call a maintenance personnel can eliminate an unnecessary maintenance cost.

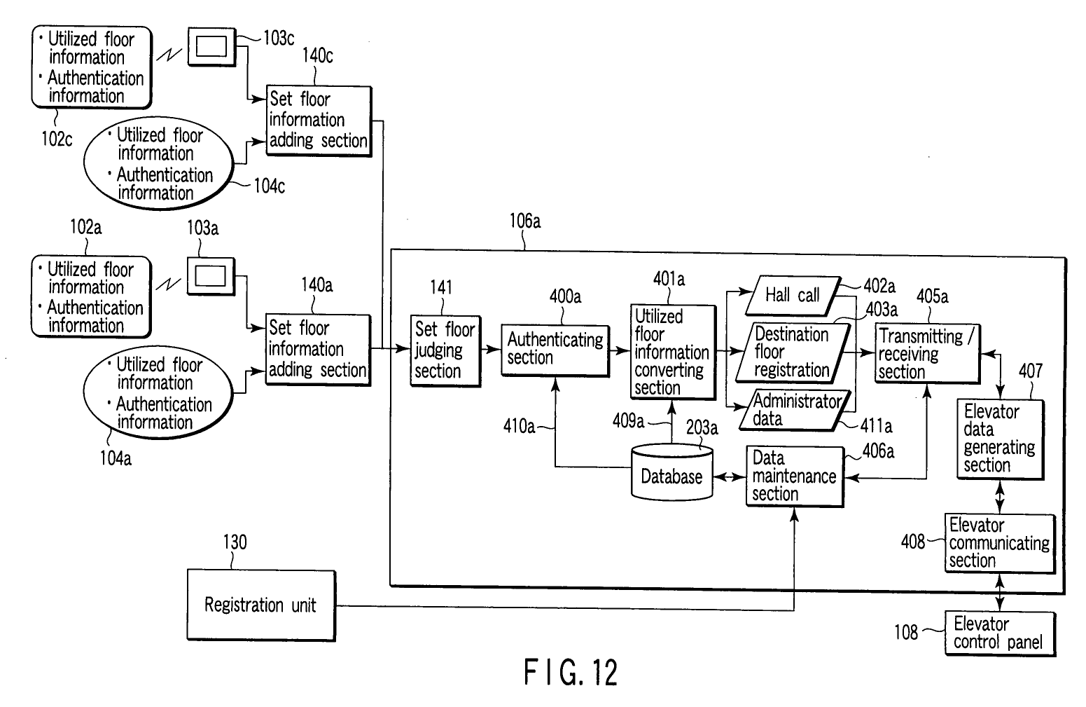

It is to be noted that this system can be modified as shown in FIG. 12, for example. That is, there are provided set floor adding sections 140a and 140c which receive information from the antennas 103a and 103c and the fingerprint authentication devices 104a and 104c in the block diagram of FIG. 2, and a set floor judging section 141 which receives output signals from these set floor adding sections 140a and 140c.

The set floor adding sections 140a and 140c have a function of adding information of set floors where the set floor adding sections 140a and 140c are set to authentication information supplied from the antennas 103a and 103c and the fingerprint authentication devices 104a and 104c. When the authentication information and the set floor information are transmitted to the set floor judging section 141 in the RFID/fingerprint common control device 106, it is possible to determine a floor from which the authentication information is output. As a result, the authenticating section 400a can grasp contents of the authentication information and the floor as a generation source of this authentication information, ( thereby appropriately calling an elevator.

That is, the RFID/fingerprint common control device 106c used in FIG. 2 can be eliminated, and the function of this device can be provided to the RFID/fingerprint common control device 106a side.

It is to be noted that the case where the RFID card reader or the fingerprint authentication device is set in the elevator hall on each floor is assumed in the respective foregoing embodiments, but the same configuration can be applied to a case where such a device is set in the car of each elevator, and the registration unit 130 can be used to easily perform the data updating operation.

Additionally, the present invention is effective when using any information (biometric information) belonging to biometric authentication. Specifically, it is possible to carry out in the form of face authentication, iris authentication, vein authentication, handwriting authentication, voice authentication, palm shape authentication or the like.

It is to be noted that further characteristics and changes can be conceived by persons skilled in this technical field. Therefore, the present invention is based on an extensive viewpoint, and it is not restricted to specific particulars and typical embodiments disclosed herein.

Therefore, various modifications can be carried out in an extensive concept of the invention defined in attached claims without departing from reading and scopes of its equivalents.

As described above, according to the embodiments of the present invention, there is provided a security system for an elevator which authenticates a passenger who utilizes the elevator, comprising: an RFID card which is owned by the passenger who utilizes the elevator and stores utilized floor information of the passenger therein; an authentication device which accepts biometric information of the passenger; a control device which has a database storing data required for authentication of the passenger by the authentication device, makes reference to the database to authenticate the passenger and controls a destination floor of the elevator based on the utilized floor information of the passenger; and a portable terminal device which is provided with a function of generating data used to update the database by a predetermined operation, transmitting the updating data to the control device to rewrite contents of the database in a state where the terminal device is connected with the control device.

According to such a configuration, information of the RFID card owned by the passenger and the biometric information are read in a hall on each floor, and these data are transmitted to the control device of this system. The control device compares the received data with data previously registered in the data base in accordance with each passenger for verification, thereby authenticating the passenger. Further, if it is determined that the passenger is a proper passenger, a destination floor of the elevator is controlled based on the utilized floor information of the passenger.

Here, when the database must be updated, e.g., when biometric information of a new passenger must be added and registered, the terminal device is first used to generate updating data and transmit the generated data to the control device. As a result, contents of the database can be readily rewritten. In this case, the updating data can be generated in the terminal device at an arbitrary place. Therefore, both an administrator and a user (the passenger) do not have to go to each elevator to perform an updating operation, and a burden on both of them can be greatly reduced.

Furthermore, the security system for an elevator is characterized in that the terminal device comprises: storing means for holding the same data as that in the database; and registering means for registering biometric information of a new passenger in the storing means, the terminal device transmits data in the storing means after registering the biometric information by the registering means to the control device as updating data to be reflected in the database when the terminal device is connected with the control device at a predetermined place.

As a result, after the biometric information of a new passenger is registered in the storing means in the terminal device, the database can be easily updated in accordance with data contents of the storing means after registering the biometric information by connecting this terminal device with the control device at a predetermined place.

Moreover, the security system for an elevator is characterized in that the terminal device comprises: storing means for holding the same data as that in the database; and deleting means for deleting biometric information of an already registered passenger from the storing means, and the terminal device transmits data in the storing means after deleting the biometric information by the deleting means to the control device as updating data to be reflected in the database when the terminal device is connected with the control device at a predetermined place.

As a result, after the biometric information of the already registered passenger is deleted from the storing means in the terminal device, the database can be readily updated in accordance with data contents of the storing means after deleting the biometric information by connecting this terminal device with the control device at a predetermined place.

Additionally, the security system for an elevator is characterized in that the terminal device comprises: storing means for holding the same data as that in the database; and card inhibiting means for setting information of the RFID card which should be banned from being authenticated in the storing means, and the terminal device transmits data in the storing means after authentication ban setting by the card inhibiting means to the control device as updating data to be reflected in the database when the terminal device is connected with the control device at a predetermined place.

As a result, when, e.g., the RFID card is lost, after information of the RFID card is set in the storing means in the terminal device, the database can be easily updated in accordance with data contents in the storing means after deleting the biometric information by connecting this terminal device with the control device at a predetermined place.

Further, the security system for an elevator is characterized in that the terminal device comprises: storing means for holding the same data as that in the database; and administrator setting means for setting data which is processed as administrator data in this storing means, and the terminal device transmits data in the storing means after administrator setting by the administrator setting means to the control device as updating data to be reflected in the database when the terminal device is connected with the control device.

As a result, after data which is processed as administrator data is set in the storing means in the terminal device, the database can be easily updated in accordance with data contents in the storing means after administrator setting by connecting this terminal device with the control device at a predetermined place.

Furthermore, the security system for an elevator is characterized in that the terminal device comprises displaying means for displaying contents currently registered in the storing means in a predetermined format in a screen.

As a result, the currently registered contents can be confirmed in the screen of the terminal device and then transmitted to the control device, thereby updating the database.

Furthermore, the security system for an elevator is characterized in that the terminal device comprises displaying means for reading information of the RFID card as a defect test target and displaying a reading result as a test result in a state where the terminal device is not connected with the control device.

As a result, the administrator can use the terminal device to perform a defect test of the RFID card. Therefore, if the RFID card has a problem, just replacing the card can readily eliminate the problem without making contact with a maintenance company.

According to the present invention, when the terminal device is used to generate data for updating, just connecting this terminal device to the control device on the system side can easily update contents of the database in the control device.

In this case, when there is one terminal device, performing a registering operation once can suffice even if the number of users is large, and a conventional troublesome operation is no longer necessary. That is, the administrator and all the users go to each elevator and repeat the same data updating operation each time. Therefore, a burden on the administrator and the users can be greatly reduced.

Further, since the most recent information necessary remains in the terminal device, even if, e.g., the control device on the system side is damaged and data in the database is thereby lost, this terminal device can be used to easily perform recovery.

Furthermore, in case of a defect that information in the RFID card cannot be read, just reading this card information into the terminal device can readily confirm whether this RFID card is normally operating. Therefore, if a damage of the RFID card is a factor of the defect, just replacing the card without making contact with a maintenance company can suffice, and hence a wasteful cost for maintenance/inspection is not required.

What is claimed is:

1. A security system for an elevator which authenticates a passenger who utilizes the elevator, comprising:
an RFID card which is owned by the passenger who utilizes the elevator and stores utilized floor information of the passenger therein;
an authentication device which accepts biometric information of the passenger;
a control device which has a database storing data required for authentication of the passenger by the RFID card and the authentication device, makes reference to the database to authenticate the passenger, and controls a destination floor of the elevator based on the utilized floor information of the passenger; and
a portable terminal device provided with a function of generating data used to update the database by a predetermined operation, and transmitting the updating date to the control device when connected with the control device at a predetermined position, thereby rewriting contents of the database.

2. The security system for an elevator according to claim 1, wherein the terminal device comprises:
a storing device which holds the same data as that in the database; and
a registering device which registers biometric information of a new passenger in the storing device, and
when the terminal device is connected with the control device at a predetermined position, the terminal device transmits data in the storing device after registering the biometric information by the registering device as updating data to the control device to be reflected in the database.

3. The security system for an elevator according to claim 1, wherein the terminal device comprises:
a storing device which holds the same data as that in the database; and
a deleting device which deletes biometric information of an already registered passenger from the storing device, and
when the terminal device is connected with the control device at a predetermined position, the terminal device transmits data in the storing device after deleting the biometric information by the deleting device as updating data to the control device to be reflected in the database.

4. The security system for an elevator according to claim 1, wherein the terminal device comprises:
a storing device which holds the same data as that in the database; and
a card device which sets information of the RFID card which should be banned from being authenticated in the storing device, and
when the terminal device is connected with the control device at a predetermined position, the terminal device transmits data in the storing device after authentication ban setting by the card inhibiting device as updating data to the control device to be reflected in the database.

5. The security system for an elevator according to claim 1, wherein the terminal device comprises:
a storing device which stores the same data as that in the database; and
an administrator device which sets data which is processed as administrator data in the storing device, and
when the terminal device is connected with the control device at a predetermined position, the terminal device transmits data in the storing device after administrator setting by the administrator setting device as updating data to the control device to be reflected in the database.

6. The security system for an elevator according to claim 2, wherein the terminal device comprises:
a displaying device which displays contents currently registered in the storing device in a screen in a predetermined format.

7. The security system for an elevator according to claim 3, wherein the terminal device comprises:
a displaying device which displays contents currently registered in the storing device in a screen in a predetermined format.

8. The security system for an elevator according to claim 4, wherein the terminal device comprises:
a displaying device which displays contents currently registered in the storing device in a screen in a predetermined format.

9. The security system for an elevator according to claim 5, wherein the terminal device comprises:
a displaying device which displays contents currently registered in the storing device in a screen in a predetermined format.

10. The security system for an elevator according to claim 1, wherein the terminal device comprises:
a displaying device which reads information of the RFID card as a target of a defect test and displaying a reading result as a test result when the terminal device is not connected with the control device.
